(19) United States
(12) Patent Application Publication
(10) Pub. No.: US 2024/0220683 A1
(43) Pub. Date: Jul. 4, 2024

(54) GENERATING AND ANALYZING MATERIAL STRUCTURES BASED ON MATERIAL PARAMETERS AND MACHINE LEARNING MODELS

(71) Applicant: Volkswagon Aktiengesellschaft, Wolfsburg (DE)

(72) Inventors: Gianina Alina Negoita, San Leandro, CA (US); Wesley Teskey, Foster City, CA (US)

(21) Appl. No.: 18/102,669

(22) Filed: Jan. 27, 2023

Related U.S. Application Data
(60) Provisional application No. 63/436,357, filed on Dec. 30, 2022.

(51) Int. Cl. G06F 30/27; G06F 30/23

(52) U.S. Cl. CPC G06F 30/27; G06F 30/23; G06F 2119/14

(57) ABSTRACT

A method, apparatus and system are provided to generate and analyze material structures. A first machine learning model may generate material structures and a second machine learning model may determine stress values and strain values for the generated material structures. The material structures are generated based on material parameters.

### CROSS-REFERENCE TO RELATED APPLICATIONS

This application claims priority from and the benefit of U.S. Provisional Patent Application No. 63/436,357 entitled “GENERATING AND ANALYZING MATERIAL STRUCTURES BASED ON MATERIAL PARAMETERS AND MACHINE LEARNING MODELS,” filed on Dec. 30, 2022, the entire contents of which are incorporated herein by reference in their entirety.

### TECHNICAL FIELD

Aspects of the present disclosure relate to generating and analyzing material structures, and more particularly, to generating and analyzing material structures based on machine learning models and material parameters.

### BACKGROUND

Various different materials (e.g., metals, alloys, polymers, ceramics, composites, etc.) can be used for various different purposes and/or applications. For example, a material may be used in as a casing or enclosure for a battery (e.g., a casing for an electric vehicle (EV) battery). All materials have a material structure. The material structure may be the physical structure and/or arrangements of the components of a material (or the components of multiple materials for composite materials). The material structure of a material may also affect, determine, etc., the properties of a material. For example, the amount of stress and/or strain that a material can accommodate/handle may be based on the material structure (e.g., the structure of the material).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system architecture, in accordance with one or more embodiments of the present disclosure.

FIG. 2 is a diagram illustrating an example material generation system, in accordance with one or more embodiments of the present disclosure.

FIG. 3 is a block diagram illustrating an example machine learning model, in accordance with one or more embodiments of the present disclosure.

FIG. 4 is a block diagram illustrating an example machine learning model, in accordance with one or more embodiments of the present disclosure.

FIG. 5 is a block diagram illustrating an example machine learning model, in accordance with one or more embodiments of the present disclosure.

FIG. 6 is a flow diagram of a process for generating material structures, in accordance with one or more embodiments of the present disclosure.

FIG. 7 is a block diagram of an example computing device that may perform one or more of the operations described herein, in accordance with some embodiments of the present disclosure.

### DETAILED DESCRIPTION

As discussed above, all materials (e.g., metals, alloys, polymers, ceramics, composites, etc.) have a structure (e.g., a material structure). The material structure may be the physical structure and/or arrangements of the components of a material (or the components of multiple materials for composite materials). The structure of a material (such as metals, polymers, ceramics or composites) may influence and/or affect various properties of the material (e.g., physical properties, chemical properties, etc.). Such properties may include an amount of stress and/or strain that the material can accommodate, strength, toughness, corrosion resistance, high/low temperature behavior, ductility, hardness, wear resistance, amount of energy stored, conductivity, etc.

Creating, generating, constructing, etc., a new material structure is often a manual process performed by specialists/experts. For example, generating a new material structure is typically done via experimentation and/or finite element analysis (FEA). Thus, generating new material structures may be a challenging and/or expensive process. In addition, generating new material structure is a time consuming process, which makes it even more difficult to generate and test out new materials quickly within a given time period. For example, experimentation (e.g., physical experimentation such as creating/manufacturing a material) and performing FEA analysis may take days, months, or even years.

The examples, implementations, and embodiments described herein may help address these issues, among others, when generating and analyzing various materials (e.g., material properties). In one embodiment, a material generation system generates new material structures based on one or more material parameters (e.g., conditions, criteria, constrains, desired properties/characteristics, etc.) using a first machine learning model. The material generation system may analyze the new material structures using a second machine learning model, to determine stress/stain values for the new material structures. A finite element analysis may be performed on the material structures (or a subset of the material structures) that are generated by the first machine learning model. The stress/stain values determined using the FEA may be used to retrain or update one or more of the first machine learning model and/or second machine learning model to improve the accuracy/performance of the machine learning model when determining stress/stain values.

In one embodiment, the material generation system may simplify or streamline the process of generating, creating, designing, analyzing, testing, etc., new material structures. For example, rather than using only a manual experimentation process and finite element analysis (FEA) performed by experts/specialists, the material generation system may apply machine learning models to generate (e.g., obtain) new material structures. The material generation system may also analyze or evaluate new material structures more quickly, efficiently, etc., when compared with manual experimentation or using FEA. By generating new material structures and analyzing/evaluating the material structures using machine learning models, the material generation system may generate new material structures much more quickly, efficiently, and with less expense than previous processes/methods for creating new material structures.

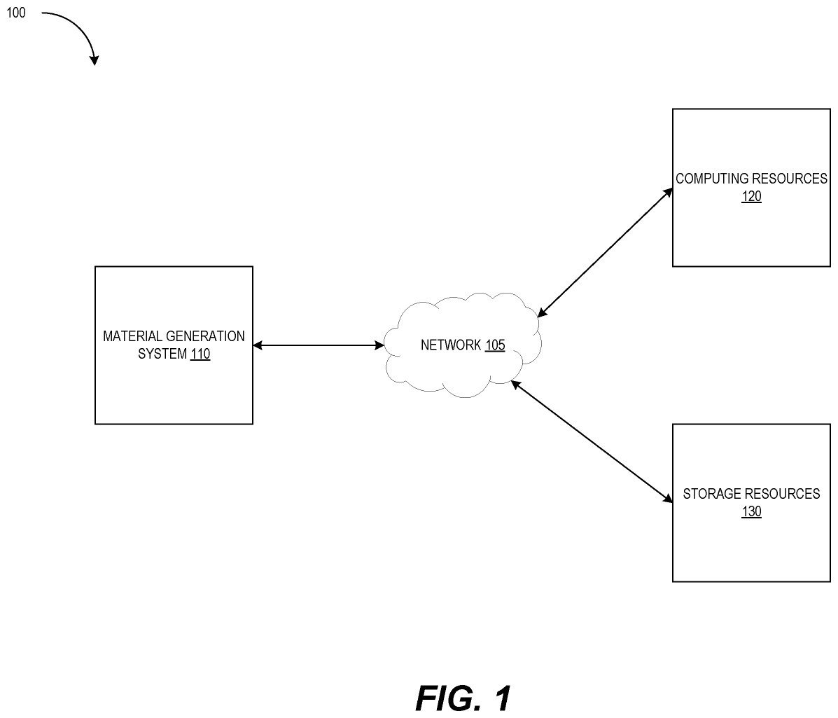

FIG. 1 is a block diagram that illustrates an example system architecture 100, in accordance with some embodiments of the present disclosure. The system architecture 100 includes network 105, a material generation system 110, computing resources 120, and storage resources 130. Network 105 may interconnect the material generation system 110, the computing resources 120, and/or the storage resources 130. Network 105 may be a public network (e.g., the internet), a private network (e.g., a local area network (LAN) or wide area network (WAN)), or a combination thereof. In one embodiment, network 105 may include a wired or a wireless infrastructure, which may be provided by one or more wireless communications systems, such as a wireless fidelity (Wi-Fi) hotspot connected with the network, a cellular system, and/or a wireless carrier system that can be implemented using various data processing equipment, communication towers (e.g., cell towers), etc. Network 105 may carry communications (e.g., data, message, packets, frames, etc.) between the material generation system 110, the computing resources 120 and/or the storage resources 130.

The computing resources 120 may include computing devices which may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The computing devices may comprise any suitable type of computing device or machine that has a programmable processor including, for example, server computers, desktop computers, rackmount servers, etc. In some examples, the computing devices may include a single machine or may include multiple interconnected machines (e.g., multiple servers configured in a cluster, cloud computing resources, etc.).

The computing resources 120 may also include virtual environments. In one embodiment, a virtual environment may be a virtual machine (VM) that may execute on a hypervisor which executes on top of the OS for a computing device. The hypervisor may also be referred to as a virtual machine monitor (VMM). A VM may be a software implementation of a machine (e.g., a software implementation of a computing device) that includes its own operating system (referred to as a guest OS) and executes application programs, applications, software. The hypervisor may be a component of an OS for a computing device, may run on top of the OS for a computing device, or may run directly on host hardware without the use of an OS. The hypervisor may manage system resources, including access to hardware devices such as physical processing devices (e.g., processors, CPUs, etc.), physical memory (e.g., RAM), storage device (e.g., HDDs, SSDs), and/or other devices (e.g., sound cards, video cards, etc.). The hypervisor may also emulate the hardware (or other physical resources) which may be used by the VMs to execute software/applications. The hypervisor may present other software (i.e., “guest” software) the abstraction of one or more virtual machines (VMs) that provide the same or different abstractions to various guest software (e.g., guest operating system, guest applications). A VM may execute guest software that uses an underlying emulation of the physical resources (e.g., virtual processors and guest memory).

In another embodiment, a virtual environment may be a container that may execute on a container engine which executes on top of the OS for a computing device, as discussed in more detail below. A container may be an isolated set of resources allocated to executing an application, software, and/or process independent from other applications, software, and/or processes. The host OS (e.g., an OS of the computing device) may use namespaces to isolate the resources of the containers from each other. A container may also be a virtualized object similar to virtual machines. However, a container may not implement separate guest OS (like a VM). The container may share the kernel, libraries, and binaries of the host OS with other containers that are executing on the computing device. The container engine may allow different containers to share the host OS (e.g., the OS kernel, binaries, libraries, etc.) of a computing device. The container engine may also facilitate interactions between the container and the resources of the computing device. The container engine may also be used to create, remove, and manage containers.

The storage resources 130 may include various different types of storage devices, such as hard disk drives (HDDs), solid state drives (SSD), hybrid drives, storage area networks, storage arrays, etc. The storage resources 130 may also include cloud storage resources or platforms which allow for dynamic scaling of storage space.

Although the computing resources 120 and the storage resources 130 are illustrated separate from the material generation system 110, one or more of the computing resources 120 and the storage resources 130 may be part of the material generation system 110 in other embodiments. For example, the material generation system 110 may include both the computing resources 120 and the storage resources 130.

As discussed above, generating, creating, developing, etc., new material structures may be a challenging, time consuming, and/or expensive process that is often performed manually by experts/specialists. The examples, implementations, and embodiments described herein may help address these issues by using machine learning models to generate material structures (e.g., to generate new or candidate material structures) and to determine the stress values and/or strain values for the generated material structures (e.g., to analyze or evaluate the generated material structures). In one embodiment, the material generation system 110 may use multiple machine learning models. For example, a first machine learning model may be used to generate material structures and a second machine learning model may be used to analyze/evaluate the material structures (e.g., to determine stress values and/or strain values for the generated material structures).

The material generation system 110 may allow generation and analysis of new material structures (e.g., determining stress/strain values) to be performed much more quickly when compared with only using finite element analysis (FEA) and/or experimentation (e.g., real or physical experimentation). For example, rather than generating and analyzing tens of new materials with FEA within a time period, material generation system 110 may be able to generate and analyze thousands or millions of different new material structures within the same time period. This may allow new materials to be developed, created, etc., more quickly and efficiently.

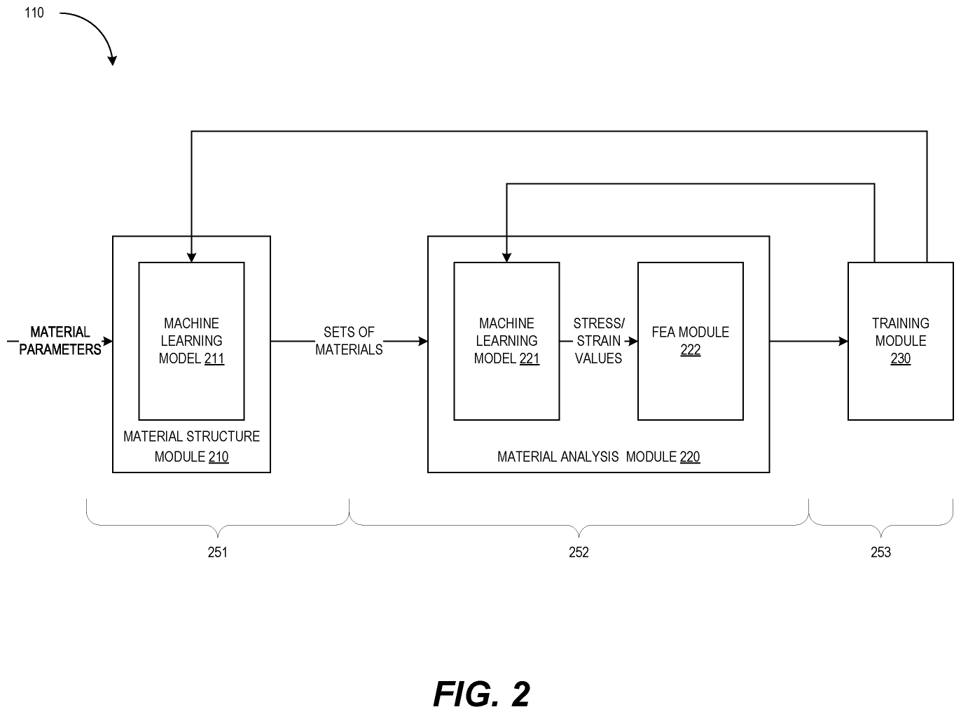

FIG. 2 is a diagram illustrating an example material generation system 110, in accordance with one or more embodiments of the present disclosure. The material generation system 110 includes a material structure module 210, a material analysis module 220, and a training module 230. Each of the material structure module 210, the material analysis module 220, and the training module 230 may be a combination of hardware, software, and firmware. In addition, any of the material structure module 210, the material analysis module 220, and the training module 230 may be distributed over multiple computing devices. Furthermore, any of the material structure module 210, the material analysis module 220, and the training module 230 may be located in cloud computing platforms and/or cloud storage platforms.

As discussed above, the material structure module 210 and/or the material analysis module 220 may include and/or may use a machine learning models to generate materials or material structures, and to determine stress values and/or strain values for portions, sections, finite elements, etc., of a material structure (e.g., for areas or portions of the material structure). The machine learning models may include one or more of a convolutional neural network (CNN), a generative adversarial network (GAN), and a conditional GAN, a neural network, a graph neural network (GNN), a recurrent neural network (RNN), a deep neural network (DNN), and a transformer network. Although the present disclosure may refer to machine learning models such as a CNN and a conditional GAN, other machine learning models may be used in other embodiments.

In one embodiment, the material structure module 210 may obtain a set of material structures based on the machine learning model 211. For example, the material structure module 210 may use the machine learning model 211 to generate one or more material structures (e.g., one or more new material structures). The material structures that are generated by the machine learning model 211 and/or the material structure module 210 may be referred to as candidate material structures.

In one embodiment, the machine learning model 211 may be a generative adversarial network (GAN). For example, the machine learning model 211 may be a conditional GAN. The conditional GAN (e.g., machine learning model 211) may generate the material structures based on one or more material parameters that are provided to the conditional GAN. The one or more material parameters may be provided to the conditional GAN as an input. A material parameter may indicate a constraint for the material or material structures. For example, a material parameter may indicate a volume fraction (e.g., the percentage of void/empty space in the volume of material), a type of the material, a type of material structure (e.g., one or more of a diamond structure, gyroid structure, primitive structure, etc.), the maximum and minimum dimensions for the volume of material, etc. A material parameter may also indicate a desired property for the material or material structure. For example, a material parameter may indicate that the material should prioritize or be optimized for a higher strength-to-weight ratio, for kinetic energy absorption, etc. In another example, a material parameter may indicate a desired weight for a material, whether the material should be suitable for particular manufacturing processes (e.g., 3-D printing, milling, etc.).

In one embodiment, the material analysis module 220 may determine sets of stress values and sets of strain values for the set of material structures that are generated by the material structure module 210 (e.g., generated by the machine learning model 211). For example, the material structure module 210 may provide the generated material structures to the machine learning model 221 as an input. The machine learning model 221 may determine a set of stress values and a set of strain values for each material structure. A stress value may indicate an amount of stress that is present at a particular point, portion, section, finite element, etc., of a material structure. A strain value may indicate an amount of strain that is present at a particular point, portion, section, finite element, etc., of a material structure.

In one embodiment, the machine learning model 221 may use voxels of the material (e.g., the material structure) to determine the set of stress values and/or the set of strain values for material. A voxel may be a unit of information that represents a point in 3-D space within the material. For example, a voxel may represent a particular portion (e.g., a unit cube at a particular location) in a volume of the material (e.g., within a larger cube of the material). The voxels may be generated by using images of 2-D slices of the volume of the material, and combining them (e.g., stacking them on top of each other, concatenating them together, etc.) to generate a voxel.

In one embodiment, a voxel may illustrate or represent a portion of a material structure (e.g., a finite element of a material structure) that is not under load. For example, the voxel may illustrate a finite element of the material when the material is not loaded or is not under or experience stress/strain. In another embodiment, a voxel may illustrate or represent a portion of a material structure (e.g., a finite element of a material structure) that is under load. For example, the voxel may illustrate a finite element of the material when the material is loaded or is under or experience stress/strain.

In one embodiment, the machine learning model 221 may be a convolutional neural network (CNN). The voxels may be provided to the CNN as an input. For example, the machine learning model 221 may perform convolution and pooling operations on the voxels of the material or material structure (e.g., voxels that represent portions of the material or material structure), to obtain, generate, determine, etc., stress values and/or strain values for a material.

As discussed above, the CNN (e.g., machine learning model 221) may also use one or more material parameters (e.g., a set of material parameters) to determine the stress values and strain values for a material. The one or more material parameters (that may be represented using a vector/array of numbers) may be provided to the CNN at the first fully connected layer of the CNN, as discussed in more detail below.

In one embodiment, the set of stress values and the set of strain values may be represented using a stress-strain curve. A stress-strain curve may be a representation of stress values and strain values displayed on a graph, where one axis of the graph (e.g., the X-axis) represents the strain values and another axis of the graph (e.g., the Y-axis) represents the stress values, or vice versa. The stress-strain curve may illustrate the relationship between the stress and the strain on a volume of material. The CNN (e.g., machine learning model 211) may generate the stress-strain curve as an output, based on the voxels of material structures that are provided as an input to the CNN. The stress-strain curve represent the stress and strain over the entire volume of the material.

In one embodiment, the machine learning model 221 may be a conditional GAN (e.g., may be a second conditional GAN that is separate from machine learning model 211). The second conditional GAN may obtain stress values and/or strain values based on voxels of material structures. For example, the second conditional GAN may use the voxels of material structures as an input. The second conditional GAN may generate stress fields and strain fields for a volume of the material structure as an output. The stress fields and strain fields may indicate the stress and/or strain at each portion or finite element of the volume of the material structure.

In one embodiment, the material analysis module 220 may determine whether the sets of stress values and the sets of strain values are within a threshold accuracy. For example, the FEA module 222 may receive the set of stress values and the set of strain values from the machine learning model 221 and may determine whether the sets of stress values and the sets of strain values are within a threshold accuracy.

In one embodiment, the material analysis module 220 (e.g., the FEA module 222) may perform finite element analysis on the one or more of the material structures (that were generated by the machine learning model 211). The finite element analysis performed on the one or more of the material structures may generate additional stress and/or strain values. For example, the finite element analysis may generate an additional set of stress values and an additional set of strain values for each material structure in that was generated by the machine learning model 211 (or for a subset of the material structures that were generated by the machine learning model 211). The FEA module 222 may compare the additional sets of stress values and the additional sets of strain values, with the stress values and strain values generated by the machine learning model 221 (e.g., generated by a CNN, a conditional GAN, etc.), to determine whether the stress values and strain values generated by the machine learning model 221 are within a threshold accuracy. The additional stress/strain values generated by the FEA module 222 may correspond to the stress/strain values generated by the machine learning model 221. For example, a stress/strain value generated by the machine learning model 221 may be for a particular location (e.g., a finite element) in a material structure, and the additional stress/strain value generated by the FEA module 222 may also be for the same particular location.

In one embodiment, the material analysis module 220 (e.g., the FEA module 222) determine whether the stress values and strain values generated by the machine learning model 221 are within a threshold accuracy by comparing the additional stress values and/or strain values generated by the FEA module 222, with the stress values and/or strain values generated by the machine learning model 221. For example, the machine learning model may compare each stress/strain value with a corresponding additional/stress/strain value. If each stress/strain value (generated by the machine learning model 221) is within a threshold of the corresponding additional stress/strain value (generated by the FEA module 222), or if a threshold number of the stress/strain values (generated by the machine learning model 221) are within a threshold of the corresponding additional stress/strain values (generated by the FEA module 222), the FEA module 222 may determine that the stress/strain values are within a threshold accuracy.

In one embodiment, in response to determining that the sets of stress values and the sets of strain values are within a threshold accuracy, the material generation system 110 may generate additional material structures. For example, if the stress/strain values are within a threshold accuracy, the material generation system 110 (e.g., the material structure module 210 and/or the machine learning model 211) may generate additional candidate material structures. The material generation system 110 (e.g., the material analysis module 220 and/or the machine learning model 221) may also determine (e.g., generate) sets of stress values and sets of strain values for the one or more additional structures based on the second machine learning model. For example, the machine learning model 221 may generate stress/strain values for the additional candidate material structures to determine if the additional candidate material structures are appropriate for a particular use/purposes (e.g., to determine if a candidate material structure can handle a particular load).

In one embodiment, the FEA module 222 may perform FEA analysis on a subset of the material structure that are generated by the machine learning model 211 and are analyzed by the machine learning model 221. For example, the machine learning model 221 may determine stress/strain values for each material structure that is generated by the machine learning model 211. The material analysis module 220 may identify or select a subset of those material structures, based on their associated stress/strain values. For example, the material analysis module 220 may identify or select material structures with stress/strain values that meet certain criteria (e.g., that may be above a threshold, may be below a threshold, etc.). The FEA module 222 may perform FEA analysis on the identified/selected material structures (e.g., on a subset of the material structures). The FEA analysis may be used to confirm, check, test, verify, etc., the stress/strain values that were generated by the machine learning model 221, for the subset of material structures. For example, the stress/strain values generated by the FEA module 222 may be compared with the stress/strain values generated by the machine learning model 221. This allows the operation or performance of the machine learning model 221 to be periodically checked/tested. This also allows the material analysis module 220 to select material structures that should used in a further experimentation process. For example, the material structures that have threshold stress/strain values and have been verified by the FEA module 222 may be used in a manual experimentation/manufacturing process that may physically create samples of the material for further testing and analysis.

In one embodiment, the material generation system 110 (e.g., the training module 230) may update one or more of the machine learning model 211 and the machine learning model 221, if the sets of stress values and the sets of strain values are within a threshold accuracy. For example, the training module 230 may retrain the machine learning model 211 and/or the machine learning model 221 based on the sets of stress/strain values (generated by the machine learning model 221) and the additional sets of stress/strain values (generated by the FEA module 222). In particular, the additional sets of stress/strain values may be used as training data to retrain one or more of the machine learning model 211 and the machine learning model 221. For example, the machine learning model 221 may be retrained (e.g., the weights of the machine learning model 221 may be updated) such that the stress/strain values generated by the updated machine learning model 221 match the additional sets of stress/strain values. In another example, the machine learning model 211 may be retrained to generate material structures with different stress/strain values (e.g., material structures that have lower stress/strain values).

As discussed above, the training module 230 may update (e.g., train, retrain, etc.) machine learning models 211 and/or 221. In one embodiment, the training module 230 may train the machine learning models 211 and/or 221 using various methods and/or different training data based on the different types of machine learning models. For example, the machine learning model 211 may be a first conditional GAN. The training module 230 may update, train, retrain, etc., the first conditional GAN using a training set of voxels and a training set of material parameters, as discussed in more detail below. In another example, the machine learning model 221 may be a CNN. The training module 230 may update, train, retrain, etc., the CNN using a training set of voxels, a training set of material parameters, and a training set of stress/strain values, as discussed in more detail below. In a further example, the machine learning model 221 may be a second conditional GAN. The training module 230 may update, train, retrain, etc., the CNN using a training set of voxels and a training set of stress/strain fields, as discussed in more detail below.

In one embodiment, the material generation system 110 may operate in a loop or process (e.g., a repeating or continuous process). The process may allow the material generation system 110 to continually generate new material structures and analyze/test the new material structures. The process may also allow the material generation system 110 to continually improve or update the machine learning model 211 and the machine learning model 221. The process may be referred to as a cycle, loop, etc. The process includes three stages (e.g., phases, parts, portions, etc.), stage 251, stage 252, and stage 253. The process 250 may proceed from stage 251, to stage 252, to stage 253, and back to stage 251. Each iteration of the process 250 may generate a set of new materials or material structures. The process 250 may iterate through the stages 251 through 253 until one or more conditions are satisfied (e.g., until a certain number of iterations have been performed, until a user indicates that the process 250 should terminate, etc.).

At stage 251, the material structure module 210 (e.g., the machine learning model 211, a conditional GAN, etc.) may generate one or more material structures (e.g., a set of material structures). For example, based on a set of material parameters, the material structure module 210 may generate new or candidate material structures, as discussed above. At stage 252, the material analysis module 220 (e.g., the machine learning model 221 and/or the FEA module 222) may analyze the material structures to determine stress/strain values for the material structures, as discussed above. The material analysis module 220 may also determine whether the stress/strain values are within a threshold accuracy, as discussed above. If the stress/strain values are not within a threshold accuracy, the process may proceed to stage 253, where the process may retrain, update, etc., the machine learning model 211 and/or machine learning model 221.

Although the present disclosure may refer to stress and/or strain as example material properties, materials with various different properties may be generated, obtained, analyzed, tested, etc., by the material generation system 110. For example, the material generation system 110 may generate material structures with resistance to heat, resistance to cold, wear resistance, conductivity, ability to hold an electric charge, etc.

In one embodiment, the material generation system 110 may allow users to create possible or candidate material structures that may be used for various applications, more quickly and/or more efficiently. For example, the material generation system 110 may be used to create, generate, etc., new material structures. The material generation system 110 may also be used to determine the stress values and/or strain values of any number of material structures (e.g., hundreds, thousands, or even millions of different types of material structures). The material generation system 110 may allow users to identify materials that meet or satisfy various material parameters. For example, the material generation system 110 may allow users generate material structures that can accommodate, handle, sustain, etc., a certain amount of stress and/or a certain amount of strain.

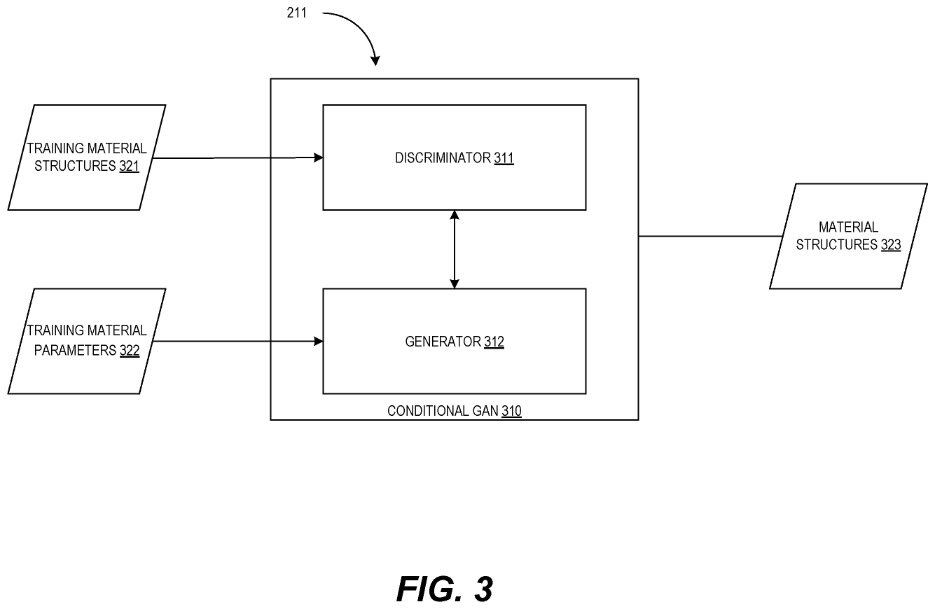

FIG. 3 is a block diagram illustrating an example machine learning model 211, in accordance with one or more embodiments of the present disclosure. As discussed above, the machine learning model 211 may be used to generate material structures (e.g., to generate candidate or possible material structures for further analysis, testing, investigation, etc.). The machine learning model 211 may be a conditional GAN 310. The conditional GAN 310 includes a discriminator 311 and a generator 312. FIG. 3 may illustrate the training of the machine learning model 211 (e.g., the conditional GAN 310).

In one embodiment, the discriminator 311 may be a portion of the conditional GAN 310 that identifies which material structures have been created by the generator 312, and which ones are existing material structures. For example, the discriminator 311 may determine whether a particular material structure was generated by the conditional GAN 310. The discriminator 311 may be trained using training material structures 321. In one embodiment, the generator 312 may be a portion of the conditional GAN 310 that generates the material structures (e.g., that generates new or candidate material structures). The new/candidate material structures may also be referred to as fake material structures or fake data. The generator 312 may be trained using training material parameters 322.

In one embodiment, the training material structures 321 and the training material parameters 322 may be correlated, associated, or related to each other. For example, a particular training material structure 321 may satisfy or meet a corresponding set of training material parameters 322. This pairing or association of material parameters and material structures during the training process may allow the conditional GAN 310 to generate material structures that have or meet certain material parameters.

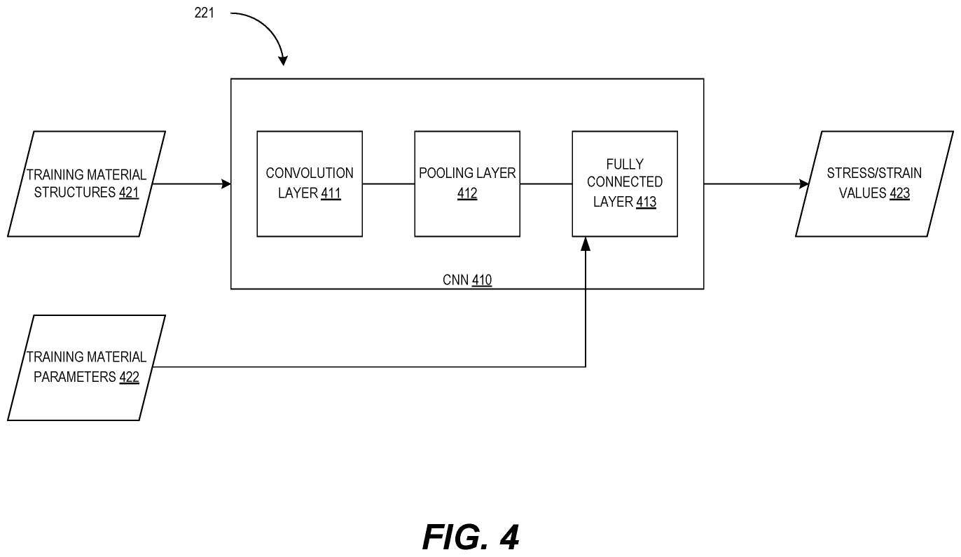

FIG. 4 is a block diagram illustrating an example machine learning model 221, in accordance with one or more embodiments of the present disclosure. As discussed above, the machine learning model 221 may be used to determine, obtain, calculate, etc., stress values and/or strain values for a material structure. The machine learning model 221 may be a CNN 410. The CNN 410 includes a convolution layer 411, a pooling layer 412, and a fully connected layer. FIG. 4 may illustrate the training of the machine learning model 221 (e.g., the CNN 410).

The training material structures 421 may be provided as an input when training the CNN 410. For example, voxels of the training material structures 421 may be passed to the convolution layer 411, then to the pooling layer 412, and finally to the fully connected layer 413. The training material parameters 422 are passed to the fully connected layer 413. For example, the training material parameters 422 may be passed to the first layer in the fully connected layer 413 (e.g., a first fully connected layer). The training material parameters 422 may be encoded as or represented using values, such as numbers. For example, the different types of geometries/structures for a material may be represented using different numbers (e.g., 1 represents a gyroid, 2 represents a diamond, 3 represents a primitive, etc.). The volume fraction may also be represented using a number that indicates the percentage of empty space within a volume of the material (e.g., 40 may indicate that a volume of the material should be forty percent empty space). The training material parameters 422 may be passed to the fully connected layer 413 using various operations, such as multiplication, addition, or other operations. Based on the training material parameters 422 and the training material structures 421, the CNN 410 may determine, calculate, generate, etc., stress/strain values 423 for the training material structures 421.

In one embodiment, the training material structures 421 and the training material parameters 422 may be correlated, associated, or related to each other. For example, a particular training material structure 421 may satisfy or meet a corresponding set of training material parameters 422. This pairing or association of material parameters and material structures during the training process may allow the CNN 410 to determine stress values and/or strain values for material structures that have or meet certain material parameters.

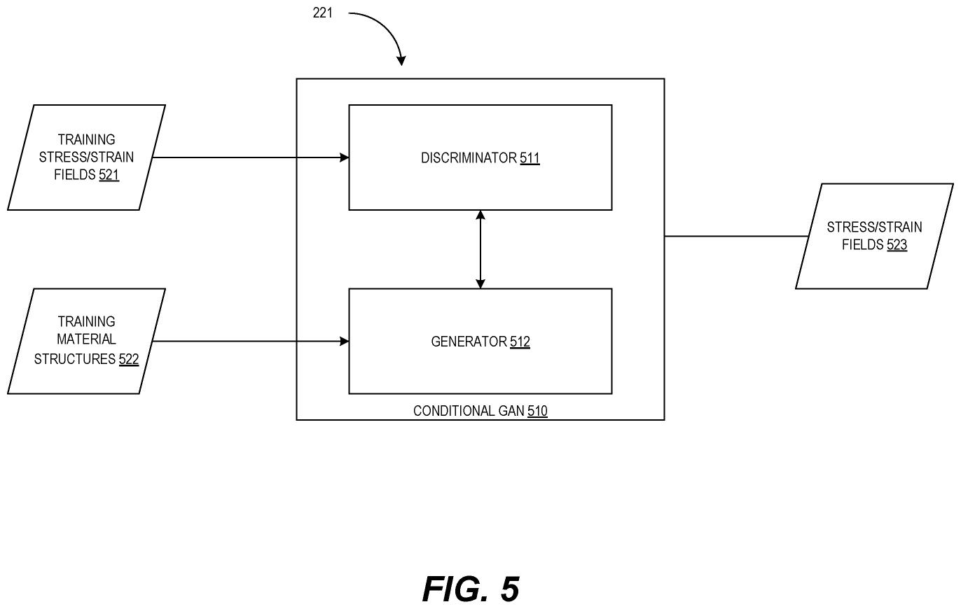

FIG. 5 is a block diagram illustrating an example machine learning model, in accordance with one or more embodiments of the present disclosure. As discussed above, the machine learning model 221 may be used to determine, obtain, calculate, etc., stress values and/or strain values for a material structure. For example, the machine learning model 221 may generate stress/strain fields 523. The machine learning model 221 may be a conditional GAN 510. The conditional GAN 510 includes a discriminator 511 and a generator 512. FIG. 5 may illustrate the training of the machine learning model 221 (e.g., the conditional GAN 510).

In one embodiment, the discriminator 511 may be a portion of the conditional GAN 510 that identifies which stress/strain fields are for material structures that were created by the generator 512, and which ones are for existing material structures. The discriminator 511 may be trained using training stress/strain fields 521. In one embodiment, the generator 512 may be a portion of the conditional GAN 510 that generates stress/strain fields for new or candidate material structures. The new/candidate material structures may also be referred to as fake material structures or fake data. The generator 512 may be trained using training material structure 522.

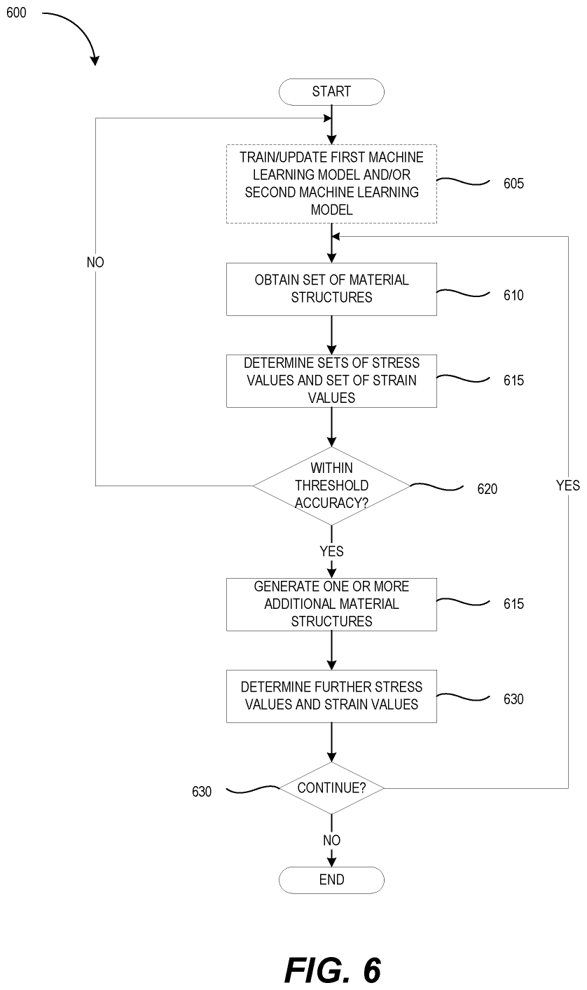

FIG. 6 is a flow diagram of a method 600 for generating material structures in accordance with one or more embodiments of the present disclosure. Method 600 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 600 may be performed by one or more computing devices or computing systems (e.g., the material generation system 110, the material structure module 210, the material analysis module 220, the machine learning model 211, the machine learning model 221, the FEA module 222, the training module 230, etc., illustrated in FIGS. 1-2).

With reference to FIG. 6, method 600 illustrates example functions used by various embodiments. Although specific function blocks (“blocks”) are disclosed in method 600, such blocks are examples. That is, embodiments are well suited to performing various other blocks or variations of the blocks recited in method 600. It is appreciated that the blocks in method 600 may be performed in an order different than presented, and that not all of the blocks in method 600 may be performed, and other blocks (which may not be included in FIG. 6) may be performed between the blocks illustrated in FIG. 6.

Method 600 begins at block 605 where the method 600 may optionally train/update a first machine learning model (e.g., machine learning model 211 illustrated in FIG. 2) and/or a second machine learning model (e.g., machine learning model 221 illustrated in FIG. 2). For example, the first and second machine learning models may be trained using training material parameters, training material structures, etc., as discussed above.

At block 610, the method 600 may obtain a set of material structures. For example, the first machine learning model may be used to generate or obtain a set of material structures (e.g., candidate material structures). At block 615, the method 600 may determine a set of stress values and/or a set of strain values for the set of material structures. For example, the second machine learning model may be used to determine the set of stress values and/or the set of strain values.

At block 620, the method 600 may determine whether the set of stress values and/or strain values are within a threshold accuracy. For example, the method 600 may perform FEA analysis to determine additional sets of stress and strain values. The additional sets of stress and strain values may be compared with the sets of strain and stress values determined at block 615. If the sets of strain values and sets of strain values are within the threshold accuracy, the method 600 may generate one or more additional material structures at block 625. The method 600 may also determine further stress values and strain values for the additional material structures at block 630. The additional material structures may be used in further experimentation and investigation to create new material structures. At block 635, the method 600 may determine whether to continue generating material structures. For example, the method 600 may determine whether a threshold number of cycles or iterations of the method 600 have been performed. If the method 600 should continue generating material structures, the method 600 may proceed to block 610.

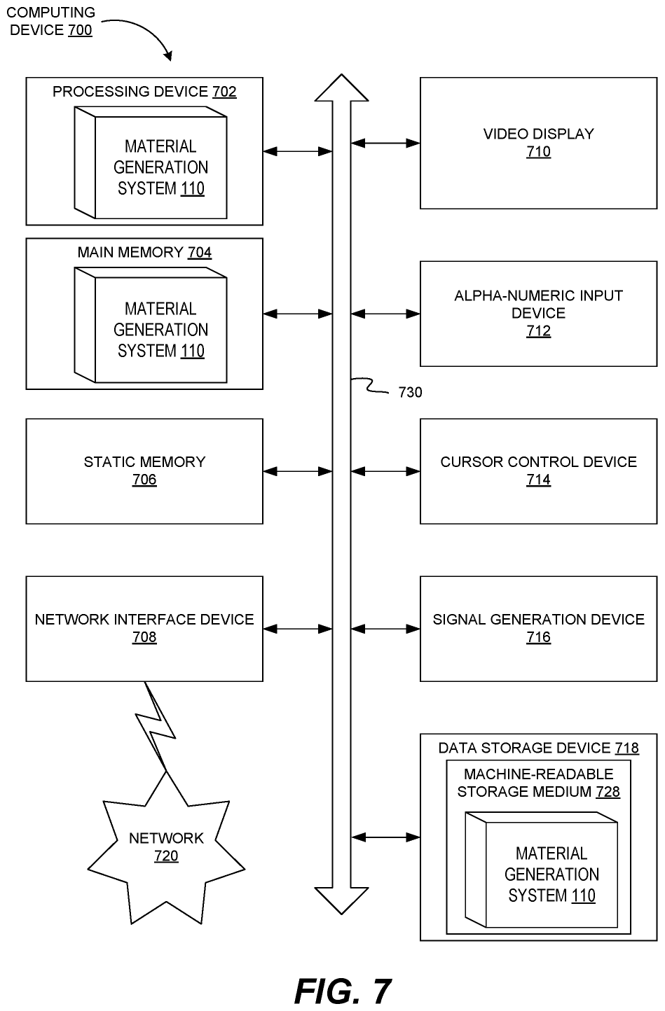

FIG. 7 is a block diagram of an example computing device 700 that may perform one or more of the operations described herein, in accordance with some embodiments. Computing device 700 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include a processing device (e.g., a general purpose processor, a PLD, etc.) 702, a main memory 704 (e.g., synchronous dynamic random access memory (DRAM), read-only memory (ROM)), a static memory 706 (e.g., flash memory and a data storage device 718), which may communicate with each other via a bus 730.

Processing device 702 may be provided by one or more general-purpose processing devices such as a microprocessor, central processing unit, or the like. In an illustrative example, processing device 702 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 702 may also comprise one or more special-purpose processing devices such as an application specific integrated circuit (ASIC), a field programmable gate array (FPGA), a digital signal processor (DSP), network processor, or the like. The processing device 702 may be configured to execute the operations described herein, in accordance with one or more aspects of the present disclosure, for performing the operations and steps discussed herein.

Computing device 700 may further include a network interface device 708 which may communicate with a network 720. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 716 (e.g., a speaker). In one embodiment, video display unit 710, alphanumeric input device 712, and cursor control device 714 may be combined into a single component or device (e.g., an LCD touch screen).

Data storage device 718 may include a computer-readable storage medium 728 on which may be stored one or more sets of instructions, e.g., instructions for carrying out the operations described herein, in accordance with one or more aspects of the present disclosure. Instructions implementing the different systems described herein (e.g., the material generation system 110, the material structure module 210, the material analysis module 220, the machine learning model 211, the machine learning model 221, the FEA module 222, etc., illustrated in FIGS. 1-2) may also reside, completely or at least partially, within main memory 704 and/or within processing device 702 during execution thereof by computing device 700, main memory 704 and processing device 702 also constituting computer-readable media. The instructions may further be transmitted or received over a network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “obtaining,” “determining,” “generating,” “performing,” “comparing,” “updating,” “training,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

When an action, function, operation, etc., is described herein as being performed automatically, this may indicate that the action, function, operation, etc., may be performed without requiring human or user input, invocation, or interaction.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
obtaining a set of material structures based on a conditional generative adversarial network (GAN) and a set of material parameters, wherein the set of material parameters are provided to the conditional GAN as an input;
determining sets of stress values and sets of strain values for the set of material structures based on a second machine learning model, the set of material parameters, and a set of voxels for the set of material structures;
determining whether the sets of stress values and the sets of strain values are within a threshold accuracy; and
in response to determining that the sets of stress values and the sets of strain values are within the threshold accuracy, generating one or more additional material structures based on the conditional GAN.

2. The method of claim 1, further comprising:
determining further sets of stress values and additional sets of strain values for the one or more additional material structures based on the second machine learning model.

3. The method of claim 1, wherein the set of material parameters comprise one or more of:
a desired property of the set of material structures; and
a constraint on the set of material structures.

4. The method of claim 1, wherein determining whether the sets of stress values and the sets of strain values are within the threshold accuracy comprises:
performing finite element analyses for the set of material structures to obtain second sets of stress value and second sets of strain values; and
comparing the sets of stress values and the sets of strain values, with the second sets of stress values and the second sets of strain values.

5. The method of claim 1, further comprising:
in response to determining that the sets of stress values and the sets of strain values are not within the threshold accuracy, updating the conditional GAN and the second machine learning model based on the sets of stress values, the sets of strain values, the second sets of stress values, and the second sets of strain values.

6. The method of claim 1, further comprising:
training the conditional GAN based on an initial set of voxels and an initial set of material parameters.

7. The method of claim 1, wherein the second machine learning model comprises a convolutional neural network (CNN).

8. The method of claim 7, further comprising:
training the CNN based on an initial set of voxels and an initial set of material parameters, wherein the initial set of material parameters are provided to the CNN at a fully connected layer of the CNN.

9. The method of claim 1, wherein the second machine learning model comprises a second conditional GAN.

10. The method of claim 9, further comprising:
training the second conditional GAN is based on an initial set of voxels and an initial set of stress values and an initial set of strain values.

11. An apparatus, comprising:
a memory to store data; and
a processing device coupled to the memory, the processing device to:
obtain a set of material structures based on a conditional generative adversarial network (GAN) and a set of material parameters, wherein the set of material parameters are provided to the conditional GAN as an input;
determine sets of stress values and sets of strain values for the set of material structures based on a second machine learning model, the set of material parameters, and a set of voxels for the set of material structures;
determine whether the sets of stress values and the sets of strain values are within a threshold accuracy; and
in response to determining that the sets of stress values and the sets of strain values are within the threshold accuracy, generate one or more additional material structures based on the conditional GAN.

12. The apparatus of claim 11, wherein the processing device is further to:
determine further sets of stress values and additional sets of strain values for the one or more additional material structures based on the second machine learning model.

13. The apparatus of claim 11, wherein to determine whether the sets of stress values and the sets of strain values are within the threshold accuracy the processing device is further to:
perform finite element analyses for the set of material structures to obtain second sets of stress value and second sets of strain values; and
compare the sets of stress values and the sets of strain values, with the second sets of stress values and second sets of strain values.

14. The apparatus of claim 11, wherein the processing device is further to:
in response to determining that the sets of stress values and the sets of strain values are not within the threshold accuracy, update the conditional GAN and the second machine learning model based on the sets of stress values, the sets of strain values, the second sets of stress values, and the second sets of strain values.

15. The apparatus of claim 11, wherein the processing device is further to:
train the conditional GAN based on an initial set of voxels and an initial set of material parameters.

16. The apparatus of claim 11, wherein the second machine learning model comprises a convolutional neural network (CNN).

17. The apparatus of claim 16, wherein the processing device is further to:
train the CNN is based on an initial set of voxels and an initial set of material parameters, wherein the initial set of material parameters are provided to the CNN at a fully connected layer of the CNN.

18. The apparatus of claim 11, wherein the second machine learning model comprises a second conditional GAN.

19. The apparatus of claim 18, wherein the processing device is further to:
train the second conditional GAN is based on an initial set of voxels and an initial set of stress values and an initial set of strain values.

20. A non-transitory computer-readable storage medium including instructions that, when executed by a processing device, cause the processing device to perform operations comprising:
obtaining a set of material structures based on a conditional generative adversarial network (GAN) and a set of material parameters, wherein the set of material parameters are provided to the conditional GAN as an input;
determining sets of stress values and sets of strain values for the set of material structures based on a second machine learning model, the set of material parameters, and a set of voxels for the set of material structures;
determining whether the sets of stress values and the sets of strain values are within a threshold accuracy; and
in response to determining that the sets of stress values and the sets of strain values are within the threshold accuracy, generating one or more additional material structures based on the conditional GAN.
